(19) United States
(12) Patent Application Publication
(10) Pub. No.: US 2019/0271344 A1
(43) Pub. Date: Sep. 5, 2019

(54) METHODS AND APPARATUS FOR SECURING AN ARTICLE

(71) Applicant: CORNING INCORPORATED, CORNING, NY (US)

(72) Inventors: Daniel Robert Boughton, Naples, NY (US); James Gerard Fagan, Painted Post, NY (US); Thomas Augustus Keebler, Corning, NY (US)

(21) Appl. No.: 16/343,884

(22) PCT Filed: Oct. 20, 2017
(86) PCT No.: PCT/US2017/057631

§ 371 Date: Apr. 22, 2019

Related U.S. Application Data
(60) Provisional application No. 62/411,111, filed on Oct. 21, 2016.

(51) Int. Cl. F16B 11/00; B65G 49/06; F16B 13/08; F16B 19/02

(52) U.S. Cl. CPC F16B 11/002; B65G 49/061; B32B 17/06; F16B 19/02; F16B 13/0841

(57) ABSTRACT

A carrier apparatus including a base including an outer peripheral surface and an inner support surface, a frame to connect to the outer peripheral surface of the base, and a circumferential flange including an outer circumferential portion and an inner circumferential portion. The outer circumferential portion to be clamped between the frame and the outer peripheral surface of the base, and the inner circumferential portion to extend inward from the frame. The inner circumferential portion including an opening to be spaced a distance from the inner support surface of the base. The carrier apparatus may include an article including a first major surface, a second major surface, a thickness between the first major surface and the second major surface, and an edge extending across the thickness between the first major surface and the second major surface. Methods of processing and assembling the carrier apparatus may also be provided.

### CROSS-REFERENCE TO RELATED APPLICATIONS

This application claims the benefit of priority under 35 U.S.C. § 119 of U.S. Provisional Application Ser. No. 62/411111 filed on Oct. 21, 2016, the content of which is relied upon and incorporated herein by reference in its entirety.

### FIELD

The present disclosure relates generally to methods and apparatus for securing an article and, more particularly, to methods and apparatus for securing an article while isolating at least a portion of an edge of the article.

### BACKGROUND

Glass sheets are commonly used, for example, in display applications, for example liquid crystal displays (LCDs), electrophoretic displays (EPD), organic light emitting diode displays (OLEDs), plasma display panels (PDPs), or the like. Glass sheets are commonly fabricated by flowing molten glass to a forming body whereby a glass ribbon may be formed by a variety of ribbon forming processes, for example, slot draw, float, down-draw, fusion down-draw, rolling, or up-draw. The glass ribbon may then be subsequently divided to provide sheet glass suitable for further processing into a desired display application including, but not limited to, a screen or cover glass for mobile devices, televisions, computers, tablets, and other display monitors.

There is a demand for high quality glass sheets that include a material deposited on a major surface of the glass sheet to, for example, provide at least one of an abrasion and scratch resistant coating on the glass sheet and increase a strength of the glass sheet to prevent breakage of the glass sheet. The demand extends to glass sheets including planar (e.g., 2D) portions as well as to glass sheets including non-planar (e.g., 3D) portions. Some processes of depositing a material on the glass sheet include handling and transport of the glass sheet. For example, some glass coating deposition technologies include at least one of physical, plasma, and chemical vapor deposition that provides a coating on the glass sheet as the glass sheet is handled and transported during the coating deposition process. The coatings may be optically transparent so as to provide minimal to no interference with or distortion of images that may be displayed on or viewed through the glass sheet. Other techniques may provide a sapphire cover glass to protect the glass sheet from scratches; however, a surface coating provided by deposited a material on the glass sheet that prevents abrasions and scratches on the glass sheet and increases a strength of the glass sheet may provide a more efficient and less expensive glass sheet than, for example, a sapphire cover glass and may, therefore, be employed in a variety of display applications with significant cost savings.

Glass articles, for example cover glass, such as for example, cover glass for a mobile phone, may be manufactured with one or more surface treatments to enhance its functions and provide a positive experience for an end user. For example, cover glass may be coated with one or more coating layers to provide desired characteristics. Such coating layers may include anti-reflection coating layers, easy-to-clean coating layers, and scratch resistant coating layers. These coating layers may be applied on a surface of the cover glass using various vacuum deposition methods for example sputtering, plasma vapor deposition (PVD), chemical vapor deposition (CVD), and plasma-enhanced chemical vapor deposition (PECVD). These coating layers may be applied to an entire surface of the cover glass (e.g., an edge-to-edge coating of a cover glass surface). In some embodiments, a pressure sensitive adhesive (e.g., double-sided Kapton tape) may be used to hold the cover glass on a support plate during a coating process.

Moreover, during a coating process, it may be desirable that the material deposited on the glass sheet is deposited only on, for example, the major surface with which a user may interact. For example, a glass sheet may be provided in a touch-screen application where a user may physically contact the glass sheet to control features of a display device. Likewise, a glass sheet may be provided in an application where a major surface of the glass is provided for viewing by a user and is, therefore, exposed to the environment including dust, debris, and other objects that may scratch and abrade the surface of the glass. Thus, there is a desire for a carrier apparatus including a glass sheet to secure the glass sheet and facilitate handling and transport of the glass sheet during processing in a manner that exposes an exposed area of the major surface of the glass sheet to be coated while isolating the edge of the glass sheet and the opposing major surface of the glass sheet.

### SUMMARY

There are set forth exemplary embodiments of a carrier apparatus including an article to secure the article and facilitate handling and transport of the article during processing in a manner that exposes an exposed area of the major surface of the article to be coated while isolating the edge of the article and the opposing major surface of the articles. Methods of assembling the carrier apparatus and methods of processing the carrier apparatus are also provided.

Some exemplary embodiments of the disclosure are described below with the understanding that any of the embodiments may be used alone or in combination with one another.

Embodiment 1. A carrier apparatus may include a base including an outer peripheral surface and an inner support surface, a frame to connect to the outer peripheral surface of the base, and a circumferential flange including an outer circumferential portion and an inner circumferential portion. The outer circumferential portion may be clamped between the frame and the outer peripheral surface of the base, and the inner circumferential portion may extend inward from the frame. The inner circumferential portion may include an opening to be spaced a distance from the inner support surface of the base.

Embodiment 2. The carrier apparatus of embodiment 1 may include a cavity including a peripheral portion to be defined between the inner circumferential portion of the circumferential flange and the inner support surface of the base. The peripheral portion of the cavity may circumscribe the opening of the circumferential flange.

Embodiment 3. The carrier apparatus of any one or more of embodiments 1 and 2, the distance may range from about 0.05 mm to about 3 mm.

Embodiment 4. The carrier apparatus of any one or more of embodiments 1-3, the outer peripheral surface of the base may circumscribe the inner support surface of the base.

Embodiment 5. The carrier apparatus of any one or more of embodiments 1-4, at least a portion of the inner support surface of the base may be recessed relative to the outer peripheral surface of the base.

Embodiment 6. The carrier apparatus of embodiment 5, the base may include a lip circumscribing the recessed portion of the inner support surface of the base and extending between the recessed portion of the inner support surface of the base and the outer peripheral surface of the base.

Embodiment 7. The carrier apparatus of any one or more of embodiments 1-6, the inner circumferential portion of the circumferential flange may include a bend.

Embodiment 8. The carrier apparatus of any one or more of embodiments 1-7, the inner support surface of the base may include a planar portion.

Embodiment 9. The carrier apparatus of any one or more of embodiments 1-7, the inner support surface of the base may include a non-planar portion.

Embodiment 10. The carrier apparatus of embodiment 9, at least a portion of the non-planar portion of the inner support surface of the base may be raised relative to the outer peripheral surface of the base.

Embodiment 11. The carrier apparatus of any one or more of embodiments 9 and 10, the base may include a protrusion between the non-planar inner support surface of the base and the outer peripheral surface of the base.

Embodiment 12. A carrier apparatus may include an article including a first major surface, a second major surface, a thickness between the first major surface and the second major surface, and an edge extending across the thickness between the first major surface and the second major surface. The carrier apparatus may include a base including an outer peripheral surface and an inner support surface, and the inner support surface may support the first major surface of the article. The carrier apparatus may include a frame connected to the outer peripheral surface of the base, and a circumferential flange including an outer circumferential portion and an inner circumferential portion. The outer circumferential portion may be clamped between the frame and the outer peripheral surface of the base. The inner circumferential portion may extend inward from the frame and may contact the article, thereby securing the article to the inner support surface of the base. The inner circumferential portion of the circumferential flange may define an opening that exposes an exposed area of the second major surface of the article, and the circumferential flange may isolate at least a portion of the edge of the article from the exposed area of the second major surface of the article.

Embodiment 13. The carrier apparatus of embodiment 12, the thickness of the article may range from about 0.1 mm to about 3 mm.

Embodiment 14. The carrier apparatus of any one or more of embodiments 12 and 13, the circumferential flange may define a sealed cavity that isolates the portion of the edge of the article from the exposed area of the second major surface of the article.

Embodiment 15. The carrier apparatus of any one or more of embodiments 12-14, at least a portion of the inner support surface of the base may be recessed relative to the outer peripheral surface of the base.

Embodiment 16. The carrier apparatus of embodiment 15, the base may include a lip circumscribing the article and extending between the recessed portion of the inner support surface of the base and the outer peripheral surface of the base.

Embodiment 17. The carrier apparatus of any one or more of embodiments 15 and 16, a distance perpendicular to the recessed portion of the inner support surface of the base between the recessed portion of the inner support surface of the base and the second major surface of the article may be greater than a parallel distance between the recessed portion of the inner support surface of the base and the outer peripheral surface of the base.

Embodiment 18. The carrier apparatus of any one or more of embodiments 12-17, the inner circumferential portion of the circumferential flange may include a bend that applies a force to the article thereby securing the article to the inner support surface of the base.

Embodiment 19. The carrier apparatus of embodiment 18, the bend may include at least one of an elastically deformed portion and a plastically deformed portion of the circumferential flange.

Embodiment 20. The carrier apparatus of embodiment 18, the bend may include a preformed portion of the circumferential flange.

Embodiment 21. The carrier apparatus of any one or more of embodiments 12-20, the inner support surface of the base may include a planar portion, the first major surface of the article may include a planar portion, and the second major surface of the article may include a planar portion. The planar portion of the inner support surface of the base may engage the planar portion of the first major surface of the article.

Embodiment 22. The carrier apparatus of any one or more of embodiments 12-20, the inner support surface of the base may include a non-planar portion, the first major surface of the article may include a non-planar portion, and the second major surface of the article may include a non-planar portion. The non-planar portion of the inner support surface of the base may engage the non-planar portion of the first major surface of the article.

Embodiment 23. The carrier apparatus of embodiment 22, at least a portion of the non-planar portion of the inner support surface of the base may be raised relative to the outer peripheral surface of the base.

Embodiment 24. The carrier apparatus of any one or more of embodiments 22 and 23, the base may include a protrusion between the non-planar portion of the inner support surface of the base and the outer peripheral surface of the base, the protrusion may contact at least a portion of the edge of the article.

Embodiment 25. The carrier apparatus of any one or more of embodiments 12-24, the article may include a sheet including glass, glass-ceramic, ceramic, or combinations thereof.

Embodiment 26. A method of processing the carrier apparatus of any one or more of embodiments 12-25 may include coating the exposed area of the second major surface of the article with a coating material.

Embodiment 27. The method of embodiment 26 may include fixing the carrier apparatus to a rotatable drum, and then rotating the rotatable drum while coating the exposed area of the second major surface of the article with the coating material.

Embodiment 28. The method of any one or more of embodiments 26 and 27 may include placing the carrier apparatus in a vacuum enclosure and drawing a vacuum on the carrier apparatus within the vacuum enclosure prior to coating the exposed area of the second major surface of the article with the coating material.

Embodiment 29. A method of assembling a carrier apparatus may include placing an article on a base, the article including a first major surface, a second major surface, a thickness between the first major surface and the second major surface, and an edge extending across the thickness between the first major surface and the second major surface. The base may include an outer peripheral surface and an inner support surface, and the inner support surface may support the first major surface of the article. The method may include placing a circumferential flange relative to the base. The circumferential flange may include an outer circumferential portion and an inner circumferential portion. The method may include clamping the outer circumferential portion of the circumferential flange to the outer peripheral surface of the base. The inner circumferential portion of the circumferential flange may contact the article and define an opening that exposes an exposed area of the second major surface of the article while isolating at least a portion of the edge of the article from the exposed area.

Embodiment 30. The method of embodiment 29 may include applying a bending moment to the circumferential flange by clamping the outer circumferential portion of the circumferential flange to the outer peripheral surface of the base. The bending moment may result in a force being applied to the article by the inner circumferential portion of the circumferential flange, thereby securing the article to the inner support surface of the base.

Embodiment 31. The method of any one or more of embodiments 29 and 30 may include forming a sealed cavity by clamping the outer circumferential portion of the circumferential flange to the outer peripheral surface of the base. The portion of the edge of the article may be disposed in the sealed cavity, thereby isolating the portion of the edge of the article from the exposed area of the second major surface of the article.

Embodiment 32. The method of any one or more of embodiments 26-30, the article including a sheet including a glass, glass-ceramic, ceramic, or combinations thereof.

### BRIEF DESCRIPTION OF THE DRAWINGS

The above and other features and advantages of embodiments of the present disclosure are better understood when the following detailed description is read with reference to the accompanying drawings, in which:

FIG. 1 illustrates an exploded perspective view of an exemplary carrier apparatus including an article with a major surface including a planar portion in accordance with embodiments of the disclosure;

FIG. 2 illustrates an assembled perspective view of the exemplary carrier apparatus of FIG. 1 in accordance with embodiments of the disclosure;

FIG. 3 shows a partial cross-sectional view of the assembled exemplary carrier apparatus along line 3-3 of FIG. 2 in accordance with embodiments of the disclosure;

FIG. 4 shows an enlarged view of a portion of the partial cross-sectional view of the assembled exemplary carrier apparatus taken at view 4 of FIG. 3 in accordance with embodiments of the disclosure;

FIG. 5 illustrates an assembled perspective view of an exemplary carrier apparatus including a plurality of articles, each with a major surface including a non-planar portion in accordance with embodiments of the disclosure;

FIG. 6 shows a cross-sectional view of the assembled exemplary carrier apparatus along line 6-6 of FIG. 5 in accordance with embodiments of the disclosure;

FIG. 7 illustrates an exemplary circumferential flange of the exemplary carrier apparatus of FIG. 5 in accordance with embodiments of the disclosure;

FIG. 8 shows an enlarged view of a portion of the cross-sectional view of the assembled exemplary carrier apparatus taken at view 8 of FIG. 6 in accordance with embodiments of the disclosure;

FIG. 9 shows an enlarged view of a portion of the cross-sectional view of the assembled exemplary carrier apparatus taken at view 9 of FIG. 8 in accordance with embodiments of the disclosure;

FIG. 10 illustrates a flowchart of methods of processing a carrier apparatus in accordance with embodiments of the disclosure; and

FIG. 11 illustrates a top view of an exemplary method of processing a carrier apparatus including fixing the carrier apparatus to a rotatable drum in accordance with embodiments of the disclosure.

### DETAILED DESCRIPTION

Embodiments will now be described more fully hereinafter with reference to the accompanying drawings in which exemplary embodiments are shown. Whenever possible, the same reference numerals are used throughout the drawings to refer to the same or like parts. However, claims may encompass many different aspects of various embodiments and should not be construed as limited to the embodiments set forth herein.

As briefly indicated above, in various embodiments there are provided methods and apparatus for supporting an article. Embodiments of articles may include silicon wafers, ceramic sheets, glass-ceramic sheets, and glass sheets. In some embodiments, the article may include a sheet of glass such as a sheet containing glass or a sheet substantially or entirely fabricated from glass. The glass, if provided, may include a wide variety of glass compositions including, but not limited to, soda-lime glass, borosilicate glass, alumino-borosilicate glass, an alkali-containing glass, or an alkali-free glass. Features of the carrier apparatus discussed below will be described with reference to one or more glass sheets that may be incorporated as part of the carrier apparatus with the understanding that, unless otherwise noted, articles other than glass sheets may likewise be incorporated as part of the carrier apparatus. “Glass-ceramics” include materials produced through controlled crystallization of glass. In embodiments, glass-ceramics have about 30% to about 90% crystallinity. Non-limiting examples of glass ceramic systems that may be used include Li2O×Al2O3×nSiO2 (i.e. LAS system), MgO×Al2O3×nSiO2 (i.e. MAS system), and ZnO×Al2O3×nSiO2 (i.e. ZAS system).

Manufacturers of glass sheets (e.g., for use in liquid crystal displays “LCDs,” electrophoretic displays “EPD,” organic light emitting diode displays “OLEDs,” plasma display panels “PDPs”) often heat treat and/or chemically strengthen the glass sheets to improve or modify their properties. In some embodiments, a device is provided for supporting an article (e.g., a glass sheet) during processing. As may be appreciated, a glass sheet according to various embodiments may include one or more edges. For example, a glass sheet may be provided that has four edges and a generally square, rectangular, trapezoidal, parallelogram or other shape. In some embodiments, a round, oblong, or elliptical glass sheet may be provided that has one continuous edge. Other glass sheets having two, three, five, etc. edges may also be provided and are contemplated as being within the scope of the disclosure. Glass sheets of various sizes, including varying lengths, heights, and thicknesses, are also contemplated within the scope of the disclosure. In some embodiments, a nominal thickness (i.e., the thickness “t” discussed below and illustrated in the figures) of a central portion of the glass sheet may be less than or equal to about 3 mm, for example, from about 30 μm to about 3 mm, from about 30 μm to about 2 mm, from about 30 μm to about 1.5 mm, from about 30 μm to about 1 mm, from about 30 μm to about 750 μm, from about 30 μm to about 500 μm, from about 30 μm to about 400 μm, from about 30 μm to about 300 μm, from about 30 μm to about 200 μm, from about 30 μm to about 100 μm, from about 30 μm to about 50 μm, and all ranges and sub-ranges of thicknesses therebetween.

The glass articles, including coating layers, may be used as a cover glass, for example, and may serve to, among other things, reduce undesired reflections, prevent formation of mechanical defects in the glass (e.g., scratches or cracks), and/or provide an easy to clean transparent surface. The glass articles disclosed herein may be incorporated into another article such as an article with a display (or display articles) (e.g., consumer electronic products, including mobile phones, tablets, computers, navigation systems, wearable devices (e.g., watches) and the like), architectural articles, transportation articles (e.g., automotive, trains, aircraft, sea craft, etc.), appliance articles, or any article that requires some transparency, scratch-resistance, abrasion resistance or a combination thereof. An exemplary article incorporating any of the glass articles disclosed herein is a consumer electronic device including a housing having front, back, and side surfaces; electrical components that are at least partially inside or entirely within the housing and including at least a controller, a memory, and a display at or adjacent to the front surface of the housing; and a cover substrate at or over the front surface of the housing such that it is over the display. In some embodiments, the cover substrate may include any of the glass articles disclosed herein. In some embodiments, at least one of a portion of the housing or the cover glass may include the glass articles disclosed herein.

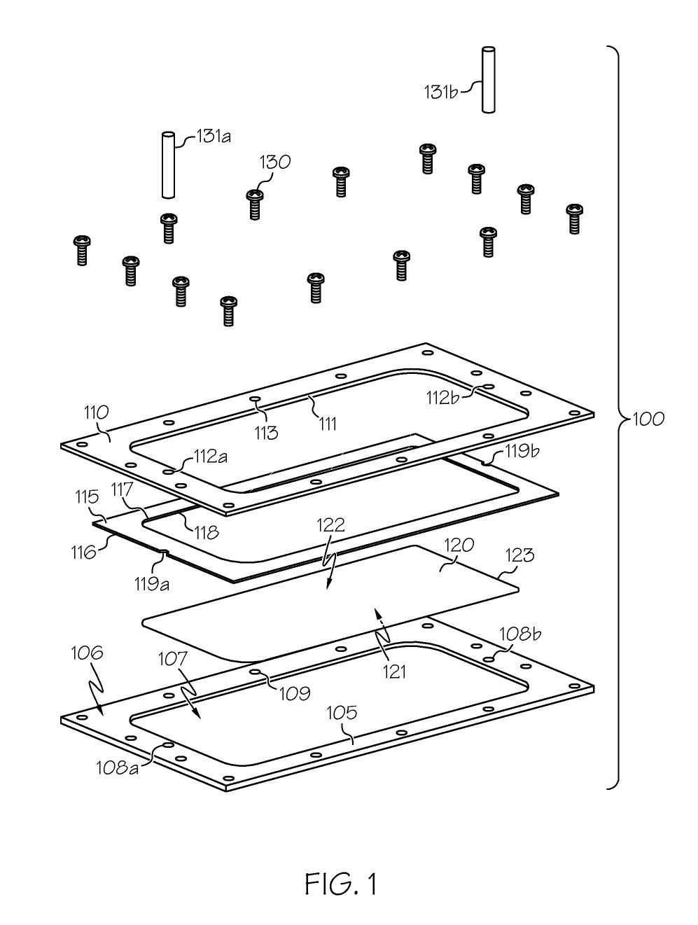

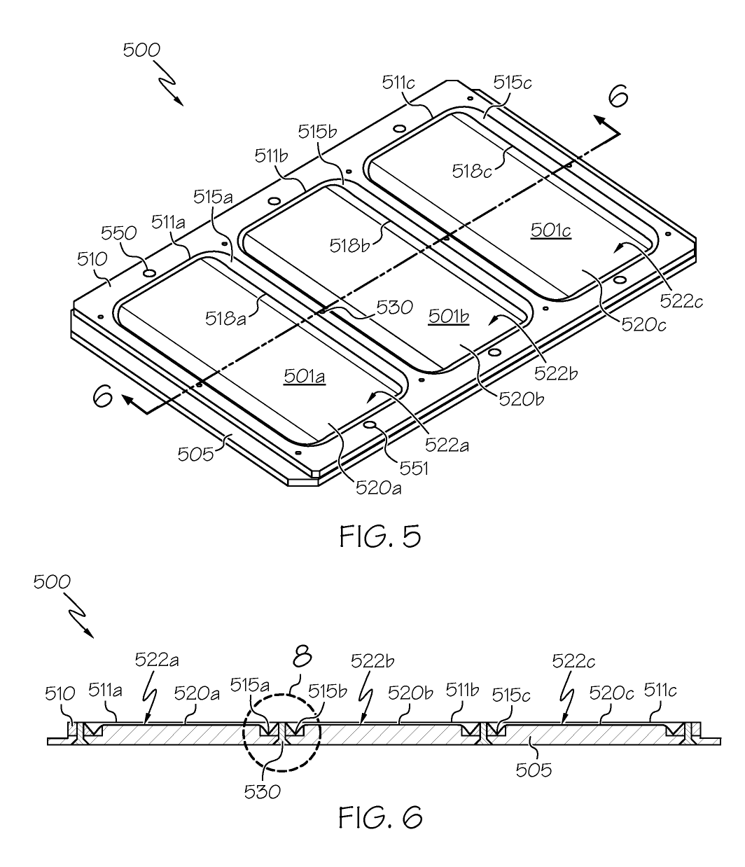

The present disclosure provides methods and apparatus for securing one or more articles, including but not limited to, a sheet including glass, glass-ceramic, ceramic, or combinations thereof. For example, FIGS. 1-4 illustrate exemplary features of a carrier apparatus 100 including an article, for example, the illustrated glass sheet 120. Additionally, FIGS. 5-9 illustrate exemplary features of another carrier apparatus 500 including a plurality of articles, for example the illustrated plurality of glass sheets 520a, 520b, 520c. As shown, the carrier apparatus 100 may include the article (e.g., the illustrated glass sheet 120) and/or the carrier apparatus 500 may include the plurality of articles (e.g., the illustrated plurality of glass sheets 520a, 520b, 520c). In some embodiments, the carrier apparatus 100, 500 may be provided without the articles. For example, the carrier apparatus 100 may be provided without the illustrated glass sheet 120, where the carrier apparatus 100 may be considered complete without the article. Likewise, the carrier apparatus 500 may be provided without the illustrated plurality of glass sheets 520a, 520b, 520c, where the carrier apparatus 500 may be considered complete without the plurality of articles. Accordingly, in some embodiments, the carrier apparatus 100, 500 may later be provided with an article or plurality of articles for incorporation as part of the carrier apparatus 100, 500.

Unless otherwise noted, one or more features of the carrier apparatus 100 may be combined alone or in any combination with one or more features of the carrier apparatus 500. In addition, although illustrated as including a single glass sheet 120, in some embodiments, the carrier apparatus 100 may be modified, in accordance with features of the disclosure, to include a plurality of glass sheets. Similarly, although illustrated as including a plurality of glass sheets 520a, 520b, 520c, in some embodiments, the carrier apparatus 500 may be modified, in accordance with features of the disclosure, to include a single glass sheet. Moreover, although three glass sheets 520a, 520b, 520c are illustrated in FIGS. 5-9, the carrier apparatus 500 (as well as the carrier apparatus 100) may be modified, in accordance with features of the disclosure, to include one, two, three, four, or more glass sheets, in some embodiments, without departing from the scope of the disclosure. Furthermore, in some embodiments, the carrier apparatus 100 and the carrier apparatus 500 may include one or more glass sheets that include at least one of a planar portion and a non-planar portion, without departing from the scope of the disclosure.

FIG. 1 illustrates an exploded perspective view of the exemplary carrier apparatus 100 in accordance with embodiments of the disclosure. In some embodiments, the carrier apparatus 100 may include a glass sheet 120 including a first major surface 121, a second major surface 122, a thickness “t” (shown in FIG. 4) between the first major surface 121 and the second major surface 122, and an edge 123 extending across the thickness “t” between the first major surface 121 and the second major surface 122. In some embodiments, the edge 123 of the glass sheet 120 may include a planar edge surface extending across at least a portion of the thickness “t” between the first major surface 121 and the second major surface 122. Moreover, in some embodiments, the edge 123 may include a non-planar edge surface extending across at least a portion the thickness “t” between the first major surface 121 and the second major surface 122. Additionally, in some embodiments, the edge 123 of the glass sheet 120 may include a corner between the planar edge surface and at least one of the first major surface 121 and the second major surface 122. Similarly, in some embodiments, the edge 123 of the glass sheet 120 may include a corner between the non-planar edge surface and at least one of the first major surface 121 and the second major surface 122. In some embodiments, the corner may include a square corner where at least one of the first major surface 121 and the second major surface 122 connects to the planar edge surface at a substantially 90-degree angle. Alternatively, in some embodiments, the corner may include a rounded corner, a cut corner, a chamfered corner, a beveled corner, or other shape corner that connects at least one of the first major surface 121 and the second major surface 122 to the planar edge surface or to the non-planar edge surface. Accordingly, for purposes of the disclosure, irrespective of shape, the edge 123 of the glass sheet 120 may be defined as the surface extending across the thickness “t” of the glass sheet 120 between the first major surface 121 and the second major surface 122 and circumscribing the first major surface 121 and the second major surface 122, thereby forming the outer periphery of the glass sheet 120.

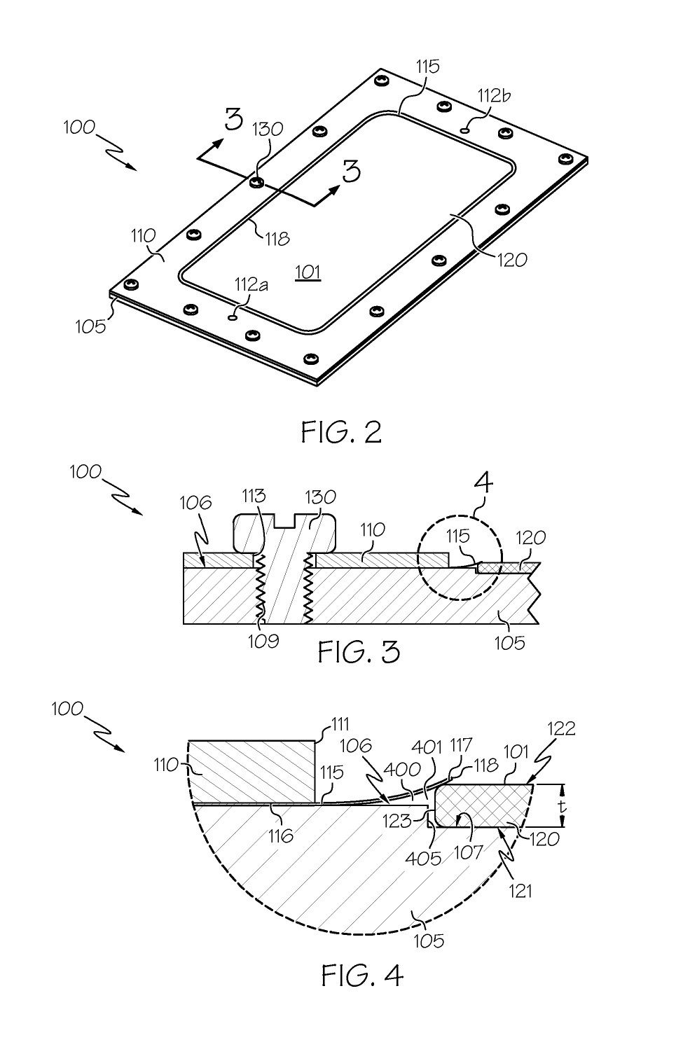

As further illustrated in FIG. 1, in some embodiments, the carrier apparatus 100 may include a base 105 including an outer peripheral surface 106 and an inner support surface 107. In some embodiments, the outer peripheral surface 106 of the base 105 may circumscribe the inner support surface 107 of the base 105. For example, in some embodiments, a portion of the outer peripheral surface 106 of the base 105 may circumscribe a portion of the inner support surface 107 of the base 105. Alternatively, in some embodiments, the outer peripheral surface 106 of the base 105 may circumscribe the entire inner support surface 107 of the base 105. Additionally, in some embodiments, as schematically illustrated in FIG. 4, the inner support surface 107 of the base 105 may engage the first major surface 121 of the glass sheet 120. FIG. 2 illustrates an assembled perspective view of the carrier apparatus 100; FIG. 3, shows a partial cross-sectional view of the assembled carrier apparatus 100 along line 3-3 of FIG. 2; and, FIG. 4 shows an enlarged view of a portion of the partial cross-sectional view of the assembled carrier apparatus 100 taken at view 4 of FIG. 3.

Turning back to FIG. 1, in some embodiments, the carrier apparatus 100 may include a frame 110 to connect to the outer peripheral surface 106 of the base 105. Additionally, in some embodiments, the carrier apparatus 100 may include a circumferential flange 115 including an outer circumferential portion 116 and an inner circumferential portion 117. In some embodiments, as shown in FIG. 3 and FIG. 4, the outer circumferential portion 116 may be clamped between the frame 110 and the outer peripheral surface 106 of the base 105, and the inner circumferential portion 117 may extend inward from the frame 110. For example, in some embodiments, the frame 110 may include an inner circumferential opening 111, and the inner circumferential portion 117 of the circumferential flange 115 may extend inward from the inner circumferential opening 111 of the frame 110. As shown in FIG. 2, in some embodiments, the circumferential flange 115 may include an opening 118 that exposes an exposed area 101 of the second major surface 122 of the glass sheet 120. In some embodiments, the inner circumferential opening 111 of the frame 110 may be larger than the opening 118 of the circumferential flange 115 such that the inner circumferential portion 117 of the circumferential flange 115 may extend inward from the inner circumferential opening 111 of the frame 110 when the outer circumferential portion 116 of the circumferential flange 115 is clamped between the frame 110 and the outer peripheral surface 106 of the base 105.

In some embodiments, although not shown, the inner circumferential portion 117 of the circumferential flange 115 may rest or be pressed against the inner support surface 107 when the glass sheet 120 is not present such that a distance between the opening 118 of the inner circumferential portion 117 and the inner support surface 107 of the base 105 is at or about zero. Alternatively, in some embodiments, with or without the presence of the glass sheet 120, the opening 118 defined by the inner free end of the inner circumferential portion 117 may be positioned within a footprint of the inner support surface 107 and spaced from the inner support surface 107 by a distance greater than zero to less than about 4 mm, for example, from about 30 μm to about 4 mm, from about 30 μm to about 3 mm, from about 0.1 mm to about 1.5 mm, and all ranges and sub-ranges therebetween. For example, as shown in FIG. 3 and FIG. 4, with the presence of the glass sheet 120, in some embodiments the opening 118 may be positioned within the footprint of the inner support surface 107 and spaced from the inner support surface 107 by a distance from the inner support surface 107 of from about 30 μm to about 4 mm, from about 30 μm to about 3 mm, from about 0.1 mm to about 1.5 mm, and all ranges and sub-ranges therebetween.

In some embodiments, the thickness “t” of the glass sheet 120 may be greater than, equal to, or less than the distance that the opening 118 is spaced from the inner support surface 107 of the base 105. For example, as shown with reference to FIG. 4, in some embodiments, the distance that the opening 118 is spaced from the inner support surface 107 of the base 105 may be greater than the thickness “t” of the glass sheet 120.

As further shown in FIG. 4, in some embodiments, the carrier apparatus 100 may include a cavity 400 including a peripheral portion 401 defined between the inner circumferential portion 117 of the circumferential flange 115 and the inner support surface 107 of the base 105. The peripheral portion 401 of the cavity 400 may circumscribe the opening 118 of the circumferential flange 115. For example, in some embodiments, the inner circumferential portion 117 of the circumferential flange 115 may extend inward from the frame 110 and may contact the glass sheet 120, thereby securing the glass sheet 120 to the inner support surface 107 of the base 105. In some embodiments, the inner circumferential portion 117 of the circumferential flange 115 may, therefore, define the opening 118 that exposes the exposed area 101 of the second major surface 122 of the glass sheet 120, and the circumferential flange 115 may, therefore, isolate at least a portion of the edge 123 of the glass sheet 120 from the exposed area 101 of the second major surface 122 of the glass sheet 120. In some embodiments, the circumferential flange 115 may isolate the entire edge 123 of the glass sheet 120 from the exposed area 101 of the second major surface 122 of the glass sheet 120. Indeed, in some embodiments, the entire edge 123 (or a portion of the edge 123) of the glass sheet 120 may be disposed within the peripheral portion 401 of the cavity 400.

Additionally, in some embodiments, the circumferential flange 115 may isolate a portion of the second major surface 122 of the glass sheet 120 from the exposed area 101 of the second major surface 122 of the glass sheet 120. For example, in some embodiments, the circumferential flange 115 may extend onto (e.g., physically contact) a portion of the second major surface 122 of the glass sheet 120. Alternatively, in some embodiments, the circumferential flange 115 may extend over (e.g., without physically contacting) a portion of the second major surface 122 of the glass sheet 120. Unless otherwise noted, the exposed area 101 of the second major surface 122 of the glass sheet 120 may include the entire second major surface 122 of the glass sheet 120. However, in some embodiments, in order to isolate at least a portion of the edge 123 of the glass sheet 120, the circumferential flange 115 may at least one of extend onto and extend over a portion of the second major surface 122 of the glass sheet 120, thereby isolating the portion of the second major surface 122 of the glass sheet 120. In some embodiments, the isolated portion of the second major surface 122 of the glass sheet 120 may be defined as an outermost portion of the second major surface 122 of the glass sheet 120 between the edge 123 of the glass sheet 120 and the exposed area 101 of the second major surface 122 of the glass sheet 120 that circumscribes the exposed area 101 of the second major surface 122 of the glass sheet 120.

In some embodiments, the circumferential flange 115 may define a sealed cavity 400 that isolates the portion of the edge 123 of the glass sheet 120 from the exposed area 101 of the second major surface 122 of the glass sheet 120. In some embodiments, the circumferential flange 115 may define a sealed cavity 400 that isolates the entire edge 123 of the glass sheet 120 from the exposed area 101 of the second major surface 122 of the glass sheet 120. Likewise, in some embodiments, the circumferential flange 115 may define a sealed cavity 400 that isolates the portion of the second major surface 122 of the glass sheet 120 from the exposed area 101 of the second major surface 122 of the glass sheet 120. Accordingly, in some embodiments, the circumferential flange 115 may define a sealed cavity 400 that isolates one or more of a portion of the edge 123 of the glass sheet 120, the entire edge 123 of the glass sheet 120, and the portion of the second major surface 122 of the glass sheet 120 from the exposed area 101 of the second major surface 122 of the glass sheet 120. In some embodiments, the sealed cavity 400 may be impermeable to matter including solid matter, and fluid (e.g., liquid, gas) matter, thereby isolating one or more of a portion of the edge 123 of the glass sheet 120, the entire edge 123 of the glass sheet 120, and the portion of the second major surface 122 of the glass sheet 120 from the exposed area 101 of the second major surface 122 of the glass sheet 120 from such matter.

Accordingly, in some embodiments, the circumferential flange 115 may secure the glass sheet 120 to the base 105 with the inner support surface 107 of the base 105 supporting the first major surface 121 of the glass sheet 120. In some embodiments, the inner support surface 107 of the base 105 may support the first major surface 121 of the glass sheet 120 by contacting the first major surface 121 of the glass sheet 120. Alternatively, in some embodiments, a sheet of protective material (e.g., a sheet of glassine paper, a coating of material, etc.) may be positioned between the inner support surface 107 of the base 105 and the first major surface 121 of the glass sheet 120 to help protect the first major surface 121 from being scratched or otherwise damaged by the base 105. Supporting the glass sheet 120 with the inner support surface 107 of the base 105 may provide a structure to which the glass sheet 120 may be secured for further processing while distributing supportive force across the first major surface 121 of the glass sheet 120 to reduce stress concentrations in the glass sheet 120. In addition, similar to the circumferential flange 115, the base 105 may isolate at least a portion of the glass sheet 120 (e.g., the first major surface 121) from the exposed area 101 of the second major surface 122 of the glass sheet 120. Likewise, the base 105 may provide a structure by which the carrier apparatus 100 including the glass sheet 120 may be attached to one or more additional structures for at least one of processing, storage, and transportation. In some embodiments, the base 105 may also protect the glass sheet 120 from mechanical shock, vibrations, and other external forces to which the carrier apparatus 100 may be subjected.

In some embodiments, the base 105 may be solid (e.g., entirely solid); however, in some embodiments, the base 105 may be hollow, include apertures, or include a network of at least one of solid structures and hollow structures connected together with spaces between the at least one of the solid structures and the hollow structures. In some embodiments, a solid inner support surface 107 may isolate the first major surface 121 of the glass sheet 120 from the exposed area 101 of the second major surface 122 of the glass sheet 120; whereas, a base 105 including a network of at least one of solid structures and hollow structures connected together with spaces between the at least one of the solid structures and the hollow structures may expose the first major surface 121 of the glass sheet 120 to the same environment to which the exposed area 101 of the second major surface 122 of the glass sheet 120 is exposed. Thus, in some embodiments, the base 105 may be mounted to a structure to isolate the first major surface 121 of the glass sheet 120 from the exposed area 101 of the second major surface 122 of the glass sheet 120. Additionally, in some embodiments, a hollow base 105 or a base 105 including a network of at least one of solid structures and hollow structures connected together with spaces between the at least one of the solid structures and the hollow structures may be lighter than, for example, a solid base 105, and therefore may include less material, be less expensive to manufacture, and provide additional advantages when employed in accordance with embodiments of the disclosure. In some embodiments, as mentioned above, the inner support surface 107 of the base 105 may include one or more of a liner (e.g., scratch resistant paper), protrusions, and surface coating to prevent the inner support surface 107 from scratching and abrading the first major surface 121 of the glass sheet 120 when the inner support surface 107 supports the first major surface 121 of the glass sheet 120.

In some embodiments, a method of assembling the carrier apparatus 100 may include placing the glass sheet 120 on the base 105, and placing the circumferential flange 115 relative to the base 105. The method may include clamping the outer circumferential portion 116 of the circumferential flange 115 to the outer peripheral surface 106 of the base 105. For example, in some embodiments, the frame 110 may be selectively connected to the outer peripheral surface 106 of the base 105 to selectively clamp the outer circumferential portion 116 of the circumferential flange 115 to the outer peripheral surface 106 of the base 105. Selectively connecting the frame 110 to the outer peripheral surface 106 of the base 105 may permit selective clamping of the outer circumferential portion 116 of circumferential flange 115 between the frame 110 and the outer peripheral surface 106 of the base 105. In some embodiments, the glass sheet 120 may therefore be selectively secured to the base 105 with the circumferential flange 115. Thus, in some embodiments, selective clamping of the outer circumferential portion 116 of circumferential flange 115 between the frame 110 and the outer peripheral surface 106 of the base 105 may provide for at least one of selective placement of the glass sheet 120 on the base 105 and selective removal of the glass sheet 120 from the base 105. Likewise, in some embodiments, selectively connecting the frame 110 to the outer peripheral surface 106 of the base 105 may permit repeated use of one or more components of the carrier apparatus 100, thereby reducing costs, improving allocation of materials and resources, and increasing efficiency.

As shown in FIG. 1 and FIG. 2, in some embodiments, one or more fasteners 130 may be provided to clamp the outer circumferential portion 116 of the circumferential flange 115 to the outer peripheral surface 106 of the base 105. Likewise, the one or more fasteners 130 may be provided to connect the frame 110 to the outer peripheral surface 106 of the base 105 with, for example, the outer circumferential portion 116 of the circumferential flange 115 clamped between the frame 110 and the outer peripheral surface 106 of the base 105. In some embodiments, the fasteners 130 may include one or more of a clamp, a bracket, a removable rivet, a clip, a bolt, a screw, a pin, a latch, an anchor, a staple, a toggle, etc. Accordingly, unless otherwise noted, various features, including features not explicitly disclosed, may be provided in some embodiments clamp the outer circumferential portion 116 of the circumferential flange 115 to the outer peripheral surface 106 of the base 105 and to connect the frame 110 to the outer peripheral surface 106 of the base 105 without departing from the scope of the disclosure.

Additionally, in some embodiments, the frame 110 may include a corresponding one or more apertures 113 through which a respective one or more fasteners 130 may extend. Similarly, in some embodiments, the base 105 may include a corresponding one or more apertures 109 to receive the respective one or more fasteners 130. In some embodiments, the one or more apertures 109 in the base 105 may include a through-hole extending from the outer peripheral surface 106 of the base 105 through the base 105 or a blind hole extending from the outer peripheral surface 106 of the base 105 partially through the base 105. In some embodiments a nut (not shown) may be provided to secure the one or more fasteners 130 to the base 105, thereby connecting the frame 110 to the outer peripheral surface 106 of the base 105. In some embodiments, at least one of the apertures 113 in the frame 110 and the apertures 109 in the base 105 may include threads that mate with corresponding threads on the one or more fasteners 130 to secure the one or more fasteners 130 within the at least one of the apertures 113 in the frame 110 and the apertures 109 in the base 105, thereby connecting the frame 110 to the outer peripheral surface 106 of the base 105. In some embodiments, the one or more fasteners 130 may be provided so as to maintain a low profile relative to the exposed area 101 of the second major surface 122 of the glass sheet 120, thereby extending a minimal to no distance away from the exposed area 101 of the second major surface 122 of the glass sheet 120. In some embodiments, by employing one or more fasteners 130 having a low profile, the one or more fasteners 130 are less likely to interfere with subsequent processing of the carrier apparatus 100 including, but not limited to, coating the exposed area 101 of the second major surface 122 of the glass sheet 120 with a coating material. For example, in some embodiments, high profile fasteners (not shown) may block the coating material from depositing on the exposed area 101 of the second major surface 122 of the glass sheet 120. Additionally, although one or more fasteners 130 are shown as extending through the frame 110 and engaging the base 105 (e.g., engaging screw threads provided on the base 105), in some embodiments, one or more fasteners 130 may extend through the base 105 and engage the frame 110 (e.g., engage screw threads provided on the frame 110).

In some embodiments, the method of assembling the carrier apparatus 100 may include applying a bending moment to the circumferential flange 115 by clamping the outer circumferential portion 116 of the circumferential flange 115 to the outer peripheral surface 106 of the base 105. For example, the bending moment may result in a force being applied to the glass sheet 120 by the inner circumferential portion 117 of the circumferential flange 115, thereby securing the glass sheet 120 to the inner support surface 107 of the base 105. In some embodiments, the method may include forming the sealed cavity 400 by clamping the outer circumferential portion 116 of the circumferential flange 115 to the outer peripheral surface 106 of the base 105.

The portion of the edge 123 of the glass sheet 120 may be disposed in the sealed cavity 400, thereby isolating the portion of the edge 123 of the glass sheet 120 from the exposed area 101 of the second major surface 122 of the glass sheet 120. Likewise, in some embodiments, the entire edge 123 of the glass sheet 120 may be disposed in the sealed cavity 400, thereby isolating the entire edge 123 of the glass sheet 120 from the exposed area 101 of the second major surface 122 of the glass sheet 120. Moreover, in some embodiments, the portion of the second major surface 122 of the glass sheet 120 may be disposed in the sealed cavity 400, thereby isolating the portion of the second major surface 122 of the glass sheet 120 from the exposed area 101 of the second major surface 122 of the glass sheet 120. Furthermore, in some embodiments, the sealed cavity 400, alone or in combination with the inner support surface 107 of the base 105 may isolate the first major surface 121 (e.g., at least one of a portion of the first major surface 121 and the entire first major surface 121) of the glass sheet 120 from the same environment as the exposed area 101 of the second major surface 122 of the glass sheet 120.

In some embodiments, as shown in FIG. 4, the sealed cavity 400 may include an empty space (e.g., void); however, in some embodiments, (not shown) the sealed cavity 400 may conform to at least one of the glass sheet 120 and the base 105, whereby the sealed cavity 400 may not include a void. For example, as shown in FIG. 4, in some embodiments, the portion of the glass sheet 120 disposed in the sealed cavity 400 may occupy a portion of the sealed cavity 400, thereby providing a void in the sealed cavity 400. Alternatively, in some embodiments (not shown), the portion of the glass sheet 120 disposed in the sealed cavity 400 may occupy substantially the entire sealed cavity 400 with little or no void present within the sealed cavity 400. In some embodiments, a void may be reduced or eliminated by one or more processing steps. For example, as set forth below, some embodiments may include a method step of placing the carrier apparatus 100 in a vacuum enclosure and drawing a vacuum on the carrier apparatus 100. In some embodiments, the vacuum may reduce or eliminate any voids within the sealed cavity 400 and the inner circumferential portion 117 may therefore be vacuum sealed against the glass sheet 120.

To facilitate assembly of the carrier apparatus 100, in some embodiments, the carrier apparatus 100 may include one or more alignment pins 131a, 131b that may be employed to align at least one of the base 105, the glass sheet 120, the circumferential flange 115, and the frame 110 relative to one or more of each other. In some embodiments, the alignment pins 131a, 131b may include a dowel having a linear axis, a block, or other structure including one or more surfaces that may facilitate alignment. In addition, although two alignment pins 131a, 131b are illustrated, unless otherwise noted, in some embodiments, one alignment pin may be provided; and in some embodiments, more than two alignment pins may be provided, without departing from the scope of the disclosure.

In some embodiments, the alignment pins 131a, 131b may contact one or more alignment features (e.g., reliefs—including at least one of a protrusion and a recess) provided on at least one of the base 105, the circumferential flange 115, and the frame 110 to align the at least one of the base 105, the circumferential flange 115, and the frame 110 relative to each other. In some embodiments, one or more of the alignment features provided on at least one of the base 105, the circumferential flange 115, and the frame 110 may abut one or more of the alignment pins 131a, 131b to align the at least one of the base 105, the circumferential flange 115, and the frame 110 relative to each other and define a position of the at least one of the base 105, the circumferential flange 115, and the frame 110. In some embodiments, the alignments pins 131a, 131b and the alignment features may be oriented to define the positions of the at least one of the base 105, the circumferential flange 115, and the frame 110 relative to the glass sheet 120. By defining the positions of the at least one of the base 105, the circumferential flange 115, and the frame 110 relative to the glass sheet 120, the alignment pins 131a, 131b and the alignment features may provide a predetermined positioning of components of the carrier apparatus 100 relative to each other. For example, in some embodiments, the predetermined positioning of components of the carrier apparatus 100 relative to each other may ensure that the circumferential flange 115 secures the glass sheet 120 to the inner support surface 107 of the base 105, may ensure that the frame 110 connects to the outer peripheral surface 106 of the base 105 to clamp the outer circumferential portion 116 of the circumferential flange 115 to the base 105, and may ensure that the exposed area 101 of the second major surface 122 of the glass sheet 120 is exposed and at least a portion of the edge 123 of the glass sheet 120 is isolated from the exposed area 101.

In some embodiments, the alignment features provided on at least one of the base 105, the circumferential flange 115, and the frame 110 may be employed either alone (e.g., without the alignment pins 131a, 131b) or in combination with the alignment pins 131a, 131b to align the at least one of the base 105, the circumferential flange 115, and the frame 110 relative to each other and to define a position of the at least one of the base 105, the circumferential flange 115, and the frame 110. For example, in some embodiments, the base 105 may include alignment reliefs 108a, 108b that may be oriented to align with at least one of corresponding alignment reliefs 112a, 112b provided on the frame 110 and corresponding alignment reliefs 119a, 119b provided on the circumferential flange 115. Similarly, in some embodiments, the corresponding alignment reliefs 119a, 119b on the circumferential flange 115 may be oriented to align with at least one of the corresponding alignment reliefs 108a, 108b provided on the base 105 and the corresponding alignment reliefs 112a, 112b provided on the frame 110. Likewise, in some embodiments, the corresponding alignment reliefs 112a, 112b on the frame 110 may be oriented to align with at least one of the corresponding alignment reliefs 108a, 108b provided on the base 105 and the corresponding alignment reliefs 119a, 119b provided on the circumferential flange 115. Thus, in some embodiments, one or more of the alignment reliefs 108a, 108b provided on the base 105, the alignment reliefs 112a, 112b provided on the frame 110, and the alignment reliefs 119a, 119b provided on the circumferential flange 115 may be employed to align one or more of the base 105, the frame 110, and the circumferential flange 115 relative to each other.

In some embodiments, the circumferential flange 115 may be placed relative to the outer peripheral surface 106 of the base 105 with the alignment reliefs 119a, 119b of the circumferential flange 115 abutting the alignment pins 131a, 131b, thereby defining a position of the circumferential flange 115 relative to the base 105. For example, in some embodiments, the alignment pins 131a, 131b may be placed in the alignment reliefs 108a, 108b on the base 105 prior to placement of the circumferential flange 115 relative to the base 105. The circumferential flange 115 may then be positioned relative to the base 105 with the alignment reliefs 119a, 119b of the circumferential flange 115 abutting the alignment pins 131a, 131b. Alternatively, in some embodiments, the circumferential flange 115 may be placed relative to the base 105, and then the alignment pins 131a, 131b may be placed in the alignment reliefs 108a, 108b on the base 105 after placement of the circumferential flange 115 relative to the base 105. The circumferential flange 115 may then be positioned (e.g., repositioned) relative to the base 105 with the alignment reliefs 119a, 119b of the circumferential flange 115 abutting the alignment pins 131a, 131b, thereby defining the position of the circumferential flange 115 relative to the base 105.

Similarly, in some embodiments, the frame 110 may be placed relative to at least one of the base 105 and the circumferential flange 115 with the at least one of the alignment reliefs 112a, 112b of the frame 110 abutting at least one of the alignment pins 131a, 131b, thereby defining a position of the frame 110 relative to at least one of the base 105 and the circumferential flange 115. In some embodiments, one or more of the alignment pins 131a, 131b may be placed in at least one of the alignment reliefs 108a, 108b on the base 105 and the alignment reliefs 112a, 112b on the frame 110 prior to placement of the frame 110 relative to at least one of the base 105 and the circumferential flange 115. The frame 110 may then be positioned relative to at least one of the base 105 and the circumferential flange 115 with at least one of the alignment reliefs 112a, 112b of the frame 110 abutting at least one of the alignment pins 131a, 131b. Alternatively, in some embodiments, the frame 110 may be placed relative to at least one of the base 105 and the circumferential flange 115, and then one or more of the alignment pins 131a, 131b may be placed in at least one of the alignment reliefs 108a, 108b on the base 105 and the alignment reliefs 112a, 112b on the frame 110 after placement of the frame 110 relative to at least one of the base 105 and the circumferential flange 115. The frame 110 may then be positioned (e.g., repositioned) relative to at least one of the base 105 and the circumferential flange 115 with at least one of the alignment reliefs 112a, 112b of the frame 110 abutting at least one of the alignment pins 131a, 131b, thereby defining a position of the frame 110 relative to at least one of the base 105 and the circumferential flange 115.

As illustrated in FIGS. 1-4, in some embodiments, the inner support surface 107 of the base 105 may include a planar portion. For example, in some embodiments, the inner support surface 107 of the base 105 may include a planar portion, the first major surface 121 of the glass sheet 120 may include a planar portion, and the second major surface 122 of the glass sheet 120 may include a planar portion. The planar portion of the inner support surface 107 of the base 105 may support (e.g., engage) the planar portion of the first major surface 121 of the glass sheet 120. In some embodiments, at least a portion of the inner support surface 107 of the base 105 may be recessed relative to the outer peripheral surface 106 of the base 105. For example, as shown in FIG. 4, in some embodiments, the entire inner support surface 107 of the base 105 may be recessed relative to the outer peripheral surface 106 of the base 105. In some embodiments, the base 105 may include a lip 405 circumscribing the recessed portion of the inner support surface 107 of the base 105 and extending between the recessed portion of the inner support surface 107 of the base 105 and the outer peripheral surface 106 of the base 105. In some embodiments, the lip 405 may circumscribe the glass sheet 120 and may extend between the recessed portion of the inner support surface 107 of the base 105 and the outer peripheral surface 106 of the base 105. The lip 405 may provide a lateral stop to help seat the glass sheet 120 within the recessed portion of the base 105.

In some embodiments, a distance perpendicular to the recessed portion of the inner support surface 107 of the base 105 between the recessed portion of the inner support surface 107 of the base 105 and the second major surface 122 of the glass sheet 120 may be greater than a parallel distance between the recessed portion of the inner support surface 107 of the base 105 and the outer peripheral surface 106 of the base 105. For example, the lip 405 may extend the parallel distance between the recessed portion of the inner support surface 107 of the base 105 and the outer peripheral surface 106 of the base 105. Accordingly, in some embodiments, the lip 405 may provide a surface against which at least a portion of the edge 123 of the glass sheet 120 may abut, for example, either in a stationary configuration where the carrier apparatus 100 is stationary or in a non-stationary configuration where the carrier apparatus 100 is moving (e.g., during transport, handling, processing etc.). Thus, in some embodiments, the lip 405, either alone or in combination with the circumferential flange 115, may seat and thereby secure the glass sheet 120 within the recessed portion of the inner support surface 107 of the base 105. For example, in some embodiments, the circumferential flange 115 may extend from the outer peripheral surface 106 of the base 105 in a direction away from the inner support surface 107 of the base 105 to contact the glass sheet 120.

In some embodiments, a distance perpendicular to the recessed portion of the inner support surface 107 of the base 105 between the recessed portion of the inner support surface 107 of the base 105 and the second major surface 122 of the glass sheet 120 may be greater than, equal to, or less than a parallel distance between the recessed portion of the inner support surface 107 of the base 105 and the outer peripheral surface 106 of the base 105. For example, as shown in FIG. 4, the distance perpendicular to the recessed portion of the inner support surface 107 of the base 105 between the recessed portion of the inner support surface 107 of the base 105 and the second major surface 122 of the glass sheet 120 may be greater than a parallel distance between the recessed portion of the inner support surface 107 of the base 105 and the outer peripheral surface 106 of the base 105. As shown in FIG. 4, the circumferential flange 115 may extend from the outer peripheral surface 106 of the base 105 in a direction away the inner support surface 107 of the base 105 to contact the glass sheet 120. Although not shown, in alternative embodiments, the circumferential flange 115 may extend from the outer peripheral surface 106 of the base 105 in a direction toward the inner support surface 107 or parallel to the inner support surface 107 of the base 105 to contact the glass sheet 120.

The lip 405, if provided, may function as a surface against which at least a portion of the edge 123 of the glass sheet 120 may abut, for example, either in a stationary configuration where the carrier apparatus 100 is stationary or in a non-stationary configuration where the carrier apparatus 100 is moving (e.g., during transport, handling, processing etc.). Thus, in some embodiments, the lip 405, either alone or in combination with the circumferential flange 115, may seat and thereby secure the glass sheet 120 within the recessed portion of the inner support surface 107 of the base 105.

In some embodiments, based at least in part on the recessed portion of the inner support surface 107 of the base 105 being recessed relative to the outer peripheral surface 106 of the base 105, when the circumferential flange 115 is clamped to the outer peripheral surface 106 of the base 105, the inner circumferential portion 117 of the circumferential flange 115 may include a bend that provides the inner circumferential portion 117 of the circumferential flange 115 in contact with the glass sheet 120 to define the cavity 400. In some embodiments, the bend may include an elastically deformed portion of the circumferential flange 115. Additionally, in some embodiments, the bend may include a plastically deformed portion of the circumferential flange 115. For example, in some embodiments, the circumferential flange 115 may be formed (e.g., stamped, pressed, bent) to plastically deform at least a portion of the circumferential flange 115 to include a bend. Additionally, in some embodiments, the bend may include a preformed portion of the circumferential flange 115. For example, in some embodiments, the circumferential flange 115 may be manufactured (e.g., extruded, molded, injection molded, vacuum formed, cast) to preform at least a portion of the circumferential flange 115 to include a bend.

In some embodiments, the elastically deformed bend, plastically deformed bend, and/or the preformed bend may include a concave profile, a convex profile, a stepped profile, an angled profile, or other shaped profile defining at least a portion of the bend. Moreover, in some embodiments, the circumferential flange 115 may include one or more of an elastically deformed portion, a plastically deformed portion, and a preformed portion. In some embodiments, the bend of the inner circumferential portion 117 of the circumferential flange 115 (whether provided as an elastically deformed portion, a plastically deformed portion a preformed portion, or a combination of elastically deformed portions, plastically deformed portions, and preformed portions) may apply a force to the glass sheet 120, thereby securing the glass sheet 120 to the inner support surface 107 of the base 105.

In some embodiments, the circumferential flange 115 may include a metallic foil including, but not limited to, one or more of a stainless steel foil, an aluminum foil, and a titanium foil. In some embodiments, the circumferential flange 115 may include at least one of a polymeric material and an elastomeric material. For example, in some embodiments, the circumferential flange 115 may include PEEK, Teflon, silicon, plasma resistant Kalrez, Viton, polyimide, or other material that has minimal or no outgassing when subjected to desired processing temperatures, including elevated temperatures. Additionally, in some embodiments, the circumferential flange 115 may include a metallic foil including a non-abrasive coating applied to the metallic foil. In some embodiments, the circumferential flange 115 may be flexible to conform to a shape of the edge 123 of the glass sheet 120 and to include the bend when the circumferential flange 115 is clamped to the outer peripheral surface 106 of the base 105. In some embodiments, a thickness of the circumferential flange 115 may be from about 0.0125 mm to about 0.125 mm; however, other thickness may be provided in some embodiments without departing from the scope of the disclosure. For example, in some embodiments, depending on the force desired to secure the glass sheet 120 to the inner support surface 107 of the base 105, the circumferential flange 115 may be modified, in accordance with embodiments of the disclosure, to include a thickness that provides the desired securing force. Likewise, in some embodiments, depending on the force desired to secure the glass sheet 120 to the inner support surface 107 of the base 105, the material from which the circumferential flange 115 may be manufactured may be selected, in accordance with embodiments of the disclosure, to include a material that provides the desired securing force.

Once assembled, the carrier apparatus 100 including the glass sheet 120 may then be processed to, for example, deposit a material on the exposed area 101 of the second major surface 122 of the glass sheet 120. In some embodiments, the deposited material may provide an abrasion and scratch resistant coating on the glass sheet 120 and may increase strength of the glass sheet 120 to prevent breakage of the glass sheet 120. Some glass coating deposition technologies include at least one of physical, plasma, and chemical vapor deposition that provides a coating on the glass sheet 120. These processes of depositing a material on the glass sheet 120 may include handling and transport of the carrier apparatus 100 including the glass sheet 120. The surface coatings may be optically transparent so as to provide minimal to no interference with or distortion of images that may be displayed on or viewed through the glass sheet 120. Moreover, during a coating process, it may be desirable that the material deposited on the glass sheet 120 be deposited only on, for example, the major surface with which a user may interact. For example, the glass sheet 120 may be provided in a touch-screen application where a user may physically contact a major surface of the glass sheet 120 to control features of a display device. Likewise, the glass sheet 120 may be provided in an application where a major surface of the glass sheet 120 may be provided for viewing by a user and may, therefore, be exposed to the environment including dust, debris, and other objects that may scratch and abrade the major surface of the glass sheet 120. The carrier apparatus 100 including the glass sheet 120 may therefore secure the glass sheet 120 and facilitate handling and transport of the glass sheet 120 during processing in a manner that exposes the exposed area 101 of the second major surface 122 of the glass sheet 120 to be coated while isolating the edge 123 of the glass sheet 120 and the opposing first major surface 121 of the glass sheet 120 from the same environment as the exposed area 101 of the second major surface 122 of the glass sheet 120.

Isolating one or more of a portion of the edge 123 of the glass sheet 120, the entire edge 123 of the glass sheet 120, a portion of the second major surface 122 of the glass sheet 120, and the first major surface 121 of the glass sheet 120 from the same environment as the exposed area 101 of the second major surface 122 of the glass sheet 120 may provide several advantages. The advantages will be described with respect to isolating at least a portion of the edge 123 of the glass sheet 120 with the understanding that the same or similar advantages may be achieved by isolating the entire edge 123 of the glass sheet 120, by isolating a portion of the second major surface 122 of the glass sheet 120, and by isolating the first major surface 121 of the glass sheet 120. In addition, the advantages will be described with respect to isolating at least a portion of the edge 123 of the glass sheet 120 of the carrier apparatus 100 illustrated in FIGS. 1-4, with the understanding that the same or similar advantages may be achieved with the carrier apparatus 500 illustrated in FIGS. 5-9. Moreover, the advantages may apply equally to a glass sheet including a planar portion (e.g., a 2D glass sheet) as well as a glass sheet including a non-planar portion (e.g., a 3D glass sheet).

For example, in some embodiments, isolating at least a portion of the edge 123 of the glass sheet 120 from the exposed area 101 of the second major surface 122 of the glass sheet 120 may provide several advantages including, but not limited to, isolating the portion of the edge 123 of the glass sheet 120 from material that may be deposited on the exposed area 101 of the second major surface 122 of the glass sheet 120. That is, in some embodiments, material deposited on the exposed area 101 of the second major surface 122 off the glass sheet 120 may be prevented from at least one of contacting and adhering to the portion of the edge 123 of the glass sheet 120 based at least in part on the circumferential flange 115 isolating the portion of the edge 123 of the glass sheet 120 from the exposed area 101 of the second major surface 122 of the glass sheet 120. In some embodiments, preventing material from at least one of contacting and adhering to the portion of the edge 123 of the glass sheet 120 may ensure that a predetermined dimensional size of the glass sheet 120 remains unchanged during subsequent processing techniques of the carrier apparatus 100. For example, in some embodiments, the glass sheet 120 may be employed in a particular application where a particular predetermined dimensional size of the glass sheet 120 is desired. By isolating at least a portion of the edge 123 of the glass sheet 120 from the exposed area 101 of the second major surface 122 of the glass sheet 120, material deposited on the exposed area 101 of the second major surface 122 of the glass sheet 120, which may increase a dimension (e.g., along the thickness “t′) of the glass sheet 120 is prevented from increasing a dimension of the edge 123 of the glass sheet 120 based at least in part on the circumferential flange 115 isolating at least a portion of the edge 123 of the glass sheet 120.

Additionally, in some embodiments, isolating the portion of the edge 123 of the glass sheet 120 from the exposed area 101 of the second major surface 122 of the glass sheet 120, thereby preventing material from at least one of contacting and adhering to the portion of the edge 123 of the glass sheet 120, may provide improved optical characteristics of the glass sheet 120. For example, in some embodiments, material deposited on the exposed area 101 of the second major surface 122 of the glass sheet 120 may reduce, degrade, or interfere with an optical characteristic of the glass sheet 120. For example, in some embodiments, material deposited on the exposed area 101 of the second major surface 122 of the glass sheet 120 may include optical properties that differ from the optical properties of the glass sheet 120. In some embodiments, the glass sheet 120 may provide desirable optical clarity for a particular display application, and it may, therefore, be desirable to limit the amount of material deposited on the glass sheet 120. However, depositing material on the glass sheet 120 may, for example, provide a scratch resistant coating and increase the strength of the glass sheet 120, in some embodiments. Accordingly, by depositing material on the exposed area 101 of the second major surface 122 of the glass sheet 120 (e.g., only on the exposed area 101 of the second major surface 122 of the glass sheet 120) while isolating at least a portion of the edge 123 of the glass sheet 120 as well as isolating the first major surface 121 of the glass sheet 120 from the same environment as the exposed area 101 of the second major surface 122 of the glass sheet 120, the glass sheet 120 may include the scratch resistant coating and exhibit increased strength without altering the optical properties of the edge 123 of the glass sheet 120 and the first major surface 121 of the glass sheet 120.

Likewise, in some embodiments, isolating the portion of the edge 123 of the glass sheet 120 from the exposed area 101 of the second major surface 122 of the glass sheet 120, thereby preventing material from at least one of contacting and adhering to the portion of the edge 123 of the glass sheet 120, may provide a stronger edge 123 of the glass sheet 120 than, for example, an edge 123 of the glass sheet 120 to which material has adhered. For example, in some embodiments, the material may impart a stress on the edge 123 of the glass sheet 120, whereby such stress may be reduced or eliminated by isolating at least a portion of the edge 123 of the glass sheet 120.

Moreover, in some embodiments, features of the disclosure may be employed without adhesives because the circumferential flange 115 may act alone to seat the glass sheet 120 in place relative to the base 105. Consequently, some embodiments of the disclosure may be employed without subsequent steps to remove adhesive, for example, from the first major surface 121 of the glass sheet 120. As provided, features of the disclosure secure the glass sheet 120 to the base 105 while isolating the edge 123 of the glass sheet 120. In addition, features of the disclosure including, but not limited to, the base 105, the frame 110, and the circumferential flange 115 may be reusable; whereas, conventional attachment configurations may only provide for a single use and must be disposed of after each use. Accordingly, the carrier apparatus 100 of the present disclosure may provide a less expensive and more efficient method of securing a glass sheet 120. Features of the present disclosure therefore provide several advantages over known methods of securing a glass sheet.

Turning to FIGS. 5-9, the carrier apparatus 500 including a plurality of glass sheets 520a, 520b, 520c is provided. In some embodiments, the carrier apparatus 500 may include one or more features of the carrier apparatus 100. Accordingly, unless otherwise noted, features of the carrier apparatus 500 that have the same or similar structure as features of the carrier apparatus 100 as well as features of the carrier apparatus 500 that provide the same or similar function as features of the carrier apparatus 100 are described above with respect to the carrier apparatus 100, with the understanding that such features may apply in the same or similar manner to the carrier apparatus 500 without being explicitly disclosed and without departing from the scope of the disclosure.

For example, as shown in FIG. 5, in some embodiments, the carrier apparatus 500 may include a base 505, a frame 510, and a plurality of circumferential flanges 515a, 515b, 515c. Each circumferential flange of the plurality of circumferential flanges 515a, 515b, 515c may include a respective opening 518a, 518b, 518c that exposes a respective exposed area 501a, 501b, 501c of a corresponding second major surface 522a, 522b, 522c, of each glass sheet of the plurality of glass sheets 520a, 520b, 520c. In some embodiments, the carrier apparatus 500 may include one or more fasteners 530 to clamp the plurality of circumferential flanges 515a, 515b, 515c to the base 505. For example, in some embodiments, the one or more fasteners 530 may connect the frame 510 to the base 505 with the plurality of circumferential flanges 515a, 515b, 515c clamped between the frame 510 and the base 505. Additionally, in some embodiments, the carrier apparatus 500 may include one or more alignment reliefs 550, 551 as well as one or more alignment pins (not shown) to facilitate alignment of at least one of the frame 510, the base 505, and the plurality of circumferential flanges 515a, 515b, 515c relative to each other.

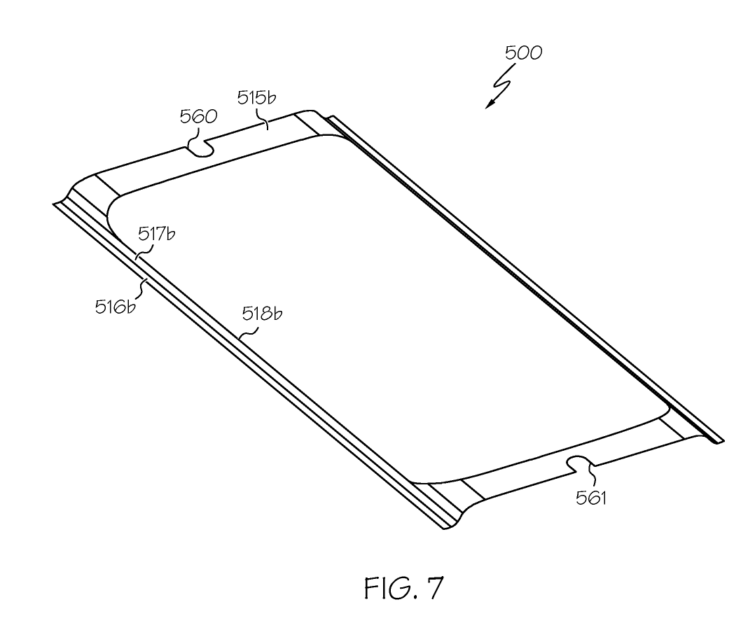

Turning to FIG. 6 which shows a cross-section view along line 6-6 of FIG. 5, in some embodiments, each circumferential flange of the plurality of circumferential flanges 515a, 515b, 515c may be clamped to the base 505 to secure each glass sheet of the plurality of glass sheets 520a, 520b, 520c to the base 505. For example, in some embodiments, the frame 510 may include a corresponding plurality of inner circumferential openings 511a, 511b, 511c, and each circumferential flange of the plurality of circumferential flanges 515a, 515b, 515c may be clamped between the frame 510 and the base 505 with a portion of each circumferential flange of the plurality of circumferential flanges 515a, 515b, 515c extending inward from a respective inner circumferential opening of the plurality of inner circumferential openings 511a, 511b, 511c of the frame 510, thereby securing each glass sheet of the plurality of glass sheets 520a, 520b, 520c to the base 505. For example, FIG. 7 illustrates circumferential flange 515b that may be identical (as shown) or different configurations as the remaining circumferential flanges 515a, 515c. As shown, the circumferential flange 515b may include an outer circumferential portion 516b that may be clamped to the base 505, and an inner circumferential portion 517b defining the opening 518b of the circumferential flange 515b. The inner circumferential portion 517b may extend inward from the frame 510 to secure the glass sheet (e.g., glass sheet 520b) to the base 505. In addition, the circumferential flange 515b may include alignment reliefs 560, 561 to facilitate alignment of the circumferential flange 515b relative to at least one of the base 505, the frame 510, and the glass sheet 520b, either alone or in combination with alignment pins (not shown).

Turning to FIG. 8 which provides an enlarged view of a portion of the cross-sectional view of the carrier apparatus 500 taken at view 8 of FIG. 6, in some embodiments, an inner support surface 507a, 507b of the base 505 may include a non-planar portion. In some embodiments, at least a portion of the non-planar portion of the inner support surface 507a, 507b of the base 505 may be raised relative to an outer peripheral surface 506a, 506b of the base 505. In some embodiments, the circumferential flange 515a may extend inward from the frame 510 to contact the glass sheet 520a, thereby securing the glass sheet 520a to the base 505. Likewise, in some embodiments, the circumferential flange 515b may extend inward from the frame 510 to contact the glass sheet 520b, thereby securing the glass sheet 520b to the base 505.

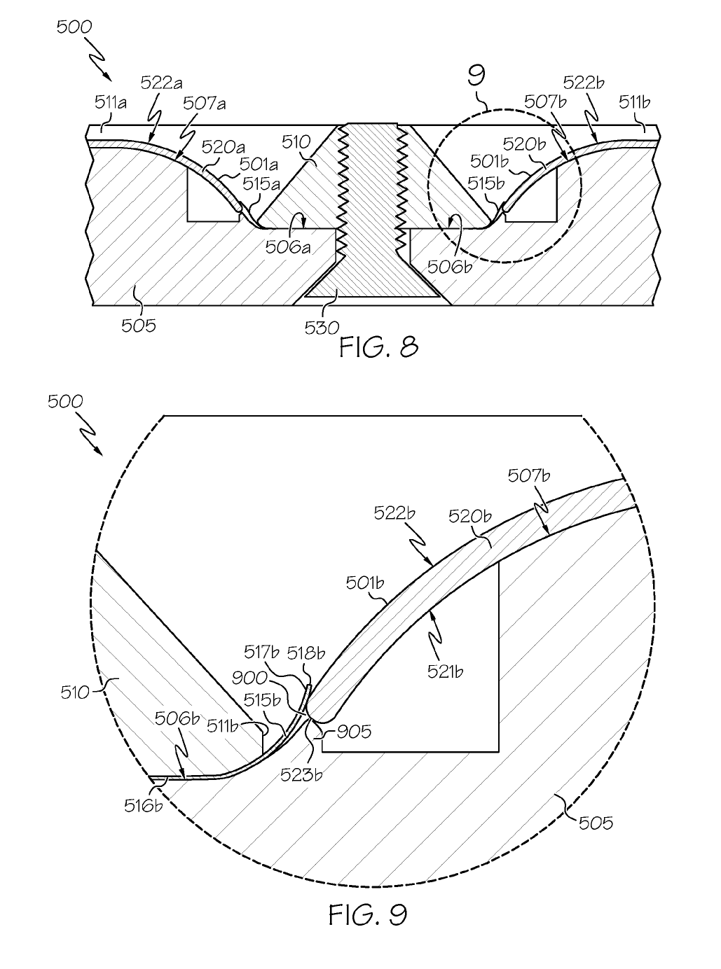

FIG. 9 shows another enlarged view of a portion of the cross-sectional view of the carrier apparatus 500 taken at view 9 of FIG. 8 illustrating a cavity 900 isolating at least a portion of the edge 523b of the glass sheet 520b. In some embodiments, the inner support surface 507b of the base 505 may include a non-planar portion, the first major surface 521b of the glass sheet 520b may include a non-planar portion, and the second major surface 522b of the glass sheet 520b may include a non-planar portion. The non-planar portion of the inner support surface 507b of the base 505 may support (e.g., engage) the non-planar portion of the first major surface 521b of the glass sheet 520b. Unless otherwise noted, the non-planar portion of the inner support surface 507b of the base 505 may have a shape that matches the non-planar portion of the first major surface 521b of the glass sheet 520b in its naturally bent orientation with no or substantially no bending moment applied to maintain the shape of the non-planar portion of the first major surface 521b. In some embodiments, providing matching shapes of the inner support surface 507b of the base 505 with the first major surface 521b of the glass sheet 520b may help reduce or eliminate stresses in the glass sheet 520b that may otherwise result from applying a bending moment to the glass sheet 520b to conform the non-planar portion of the first major surface 521b to the non-planar portion of the inner support surface 507b of the base 505. Additionally, in some embodiments, an outer circumferential portion 516b of the circumferential flange 515b may be clamped to the outer peripheral surface 506b of the base 505 with an inner circumferential portion 517b of the circumferential flange 515b extending inward from the inner circumferential opening 511b of the frame 510 to secure the glass sheet 520b to the base 505. The inner circumferential portion 517b of the circumferential flange 515b may include the opening 518b that defines the exposed area 501b of the second major surface 522b of the glass sheet 520b.

Furthermore, as shown in FIG. 4 and FIG. 9, an inner surface of the inner circumferential portion 117, 517b of the circumferential flange 115, 515b may include an inwardly facing convex surface designed to engage the outer peripheral portion of the glass sheet 120, 520b to mount the glass sheet 120, 520b in place relative to the base 105, 505 as well as to provide a seal to isolate at least a portion of the edge 123, 523b and the first major surface 121, 521b of the glass sheet 120, 520b from the exposed area 101, 501b of the second major surface 122, 522b of the glass sheet 120, 520b. In some embodiments, the inwardly facing convex surface may allow the inner circumferential portion 117, 517b of the circumferential flange 115, 515b to contact the glass sheet 120, 520b at a reduced contact area that may increase the pressure of the contact area with the glass sheet 120, 520b, thereby enhancing the ability of the inner circumferential portion 117, 517b of the circumferential flange 115, 515b to seal against the glass sheet 120, 520b. Accordingly, in some embodiments, the inwardly facing convex surface may allow the inner circumferential portion 117, 517b of the circumferential flange 115, 515b to isolate the first major surface 121, 521b and, in some embodiments, at least a portion of the edge 123, 523 of the glass sheet 120, 520b from the exposed area 101, 501b of the second major surface 122, 522b of the glass sheet 120, 520b.

In some embodiments, the base 505 may include a protrusion 905 between the non-planar portion of the inner support surface 507b of the base 505 and the outer peripheral surface 506b of the base 505. In some embodiments, the protrusion 905 may contact at least a portion of the edge 523b of the glass sheet 520b. Thus, in some embodiments, the protrusion 905, either alone or in combination with the circumferential flange 515b, may secure the glass sheet 520b to the base 505 with the inner support surface 507b of the base 505 engaging the first major surface 521b of the glass sheet 520b. Accordingly, in some embodiments, the circumferential flange 515b and the cavity 900, alone or in combination with the protrusion 905 and/or alone or in combination with the inner support surface 507b of the base 505 may isolate the first major surface 521b (e.g., at least one of a portion of the first major surface 521b and the entire first major surface 521b) of the glass sheet 520b from the exposed area 501b of the second major surface 522b of the glass sheet 520b.

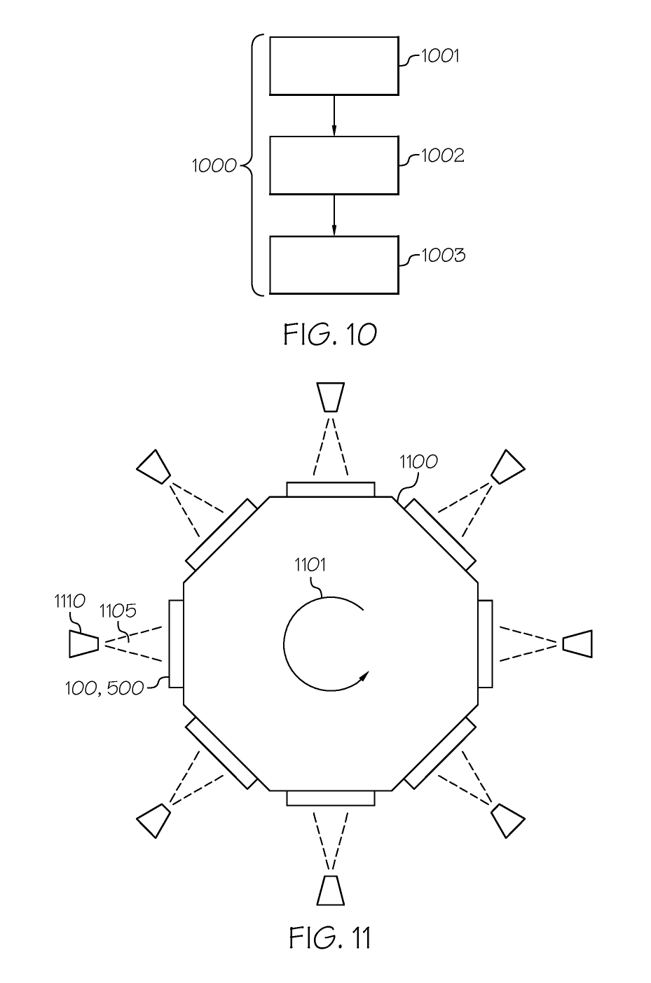

Referring to FIG. 10, in some embodiments, a method of processing 1000 a carrier apparatus (e.g., carrier apparatus 100, 500) may include providing (represented schematically by step 1001) the assembled carrier apparatus 100, 500 including one or more glass sheets (e.g., glass sheet 120, plurality of glass sheet 520a, 520b, 520c). The method may include coating an exposed area (e.g., exposed area 101, exposed areas 501a, 501b, 501c) of the second major surface (e.g., second major surface 122, second major surfaces 522a, 522b, 522c) of the glass sheet 120, 520a, 520b, 520c with a coating material (represented schematically by step 1003). In some embodiments, the method may include placing the carrier apparatus 100, 500 in a vacuum enclosure and drawing a vacuum on the carrier apparatus 100, 500 within the vacuum enclosure (represented schematically by step 1002) prior to coating the exposed area 101, 501a, 501b, 501c of the second major surface 122, 522a, 522b, 522c of the glass sheet 120, 520a, 520b, 520c with the coating material. In some embodiments, drawing a vacuum on the carrier apparatus 100, 500 may remove fluid (e.g. liquid, gas) contained on or within one or more components of the carrier apparatus 100, 500. For example, in some embodiments, drawing a vacuum on the carrier apparatus 100, 500 prior to coating the exposed area 101, 501a, 501b, 501c of the second major surface 122, 522a, 522b, 522c of the glass sheet 120, 520a, 520b, 520c with the coating material may prevent one or more components of the carrier apparatus 100, 500 from degassing and contaminating the glass sheet 120, 520a, 520b, 520c during subsequent processing including, but not limited to, the coating process. Furthermore, in some embodiments, applying the vacuum may cause the cavity 400, 900 to be placed under negative pressure once the carrier apparatus 100, 500 is removed from the vacuum enclosure. Consequently, the inner circumferential portion 117, 517b of the circumferential flange 115, 515b may be pressed against the glass sheet 120, 520b due to the pressure differential, thereby enhancing the ability of the inner circumferential portion 117, 517b to properly seat the glass sheet 120, 520b relative to the base 105, 505 and isolate at least a portion of the edge 123, 523b and the first major surface 121, 521b from the exposed area 101, 501b of the second major surface 122, 522b.

For example, as illustrated in FIG. 11, in some embodiments, the method may include fixing the carrier apparatus 100, 500 to a rotatable drum 1100, and then rotating the rotatable drum 1100 (e.g., as shown by arrow 1101) while coating the exposed area 101, 501a, 501b, 501c of the second major surface 122, 522a, 522b, 522c of the glass sheet 120, 520a, 520b, 520c with coating material. For example, in some embodiments, one or more outlets 1110 (e.g., nozzles, orifices, sprayers, jets, etc.) may be provided to spray a coating material 1105 onto the exposed area 101, 501a, 501b, 501c of the second major surface 122, 522a, 522b, 522c of the glass sheet 120, 520a, 520b, 520c while the rotatable drum 1100 is rotating as indicated at 1101. In some embodiments (not shown), other coating application techniques including, but not limited to, linear or conveyance processing, PVD, CVD, and/or PECVD, may be employed to coat the exposed area 101, 501a, 501b, 501c of the second major surface 122, 522a, 522b, 522c of the glass sheet 120, 520a, 520b, 520c with the coating material 1105.

Additionally, in some embodiments, one or more of the outlets 1110 may be provided at an angle relative to the second major surface 122, 522a, 522b, 522c of the glass sheet 120, 520a, 520b, 520c to spray the coating material 1105 onto the exposed area 101, 501a, 501b, 501c of the second major surface 122, 522a, 522b, 522c of the glass sheet 120, 520a, 520b, 520c. For example, as shown, in some embodiments, one or more of the outlets 1110 may be provided at a 90-degree angle relative to the second major surface 122, 522a, 522b, 522c of the glass sheet 120, 520a, 520b, 520c such that the one or more outlets 1110 are perpendicular to the second major surface 122, 522a, 522b, 522c of the glass sheet 120, 520a, 520b, 520c to spray the coating material 1105 onto the exposed area 101, 501a, 501b, 501c. Likewise, in some embodiments, one or more of the outlets 1110 may be provided at one or more angles (e.g., 15 degrees, 30, degrees, 45 degrees, etc.) relative to the second major surface 122, 522a, 522b, 522c of the glass sheet 120, 520a, 520b, 520c such that the one or more outlets 1110 are not perpendicular and are angled relative to the second major surface 122, 522a, 522b, 522c of the glass sheet 120, 520a, 520b, 520c to spray the coating material 1105 onto the exposed area 101, 501a, 501b, 501c. In some embodiments, providing one or more of the outlets 1110 at one or more non-perpendicular angles relative to the second major surface 122, 522a, 522b, 522c of the glass sheet 120, 520a, 520b, 520c may provide at least one of better coverage and a more uniform coating of the coating material 1105 onto the exposed area 101, 501a, 501b, 501c of the second major surface 122, 522a, 522b, 522c of the glass sheet 120, 520a, 520b, 520c, than, for example, providing one or more of the outlets 1110 at a 90-degree angle relative to the second major surface 122, 522a, 522b, 522c of the glass sheet 120, 520a, 520b, 520c. For example, in some embodiments, while the rotatable drum 1100 is rotating as indicated at 1101, providing one or more of the outlets 1110 at one or more non-perpendicular angles relative to the second major surface 122, 522a, 522b, 522c of the glass sheet 120, 520a, 520b, 520c may provide at least one of better coverage and a more uniform coating of the coating material 1105 onto the exposed area 101, 501a, 501b, 501c of the second major surface 122, 522a, 522b, 522c of the glass sheet 120, 520a, 520b, 520c.

The carrier apparatus 100, 500 including the glass sheet 120, 520a, 520b, 520c may secure the glass sheet 120, 520a, 520b, 520c during the coating processes thereby resisting forces, including but not limited to, counter forces, centrifugal forces, gravity, and inertia which may tend to separate the glass sheet 120, 520a, 520b, 520c from the base 105, 505. For example, in some embodiments, while rotating, the rotatable drum 1100 may exert a centrifugal force on the glass sheet 120, 520a, 520b, 520c exceeding, for example, ten times the force of gravity (e.g., log's) or twenty times the force of gravity (e.g., 20 g's). Accordingly, features of the disclosure may secure the glass sheet 120, 520a, 520b, 520c to the base 105, 505 with the circumferential flange 115, 515a, 515b, 515c providing a securing force sufficient to secure the glass sheet 120, 520a, 520b, 520c against centrifugal forces in excess of 10 g's or 20 g's, in some embodiments.

Directional terms as used herein-for example up, down, right, left, front, back, top, bottom-are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, such as within about 5% of each other, or within about 2% of each other.

The above embodiments, and the features of those embodiments, are exemplary and may be provided alone or in any combination with any one or more features of other embodiments provided herein without departing from the scope of the disclosure.

It will be apparent to those skilled in the art that various modifications and variations may be made to the present disclosure without departing from the spirit and scope of the disclosure. Thus, it is intended that the present disclosure cover the modifications and variations of this disclosure provided they come within the scope of the appended claims and their equivalents.

1. A carrier apparatus comprising:
a base comprising an outer peripheral surface and an inner support surface;
a frame to connect to the outer peripheral surface of the base; and
a circumferential flange comprising an outer circumferential portion and an inner circumferential portion, the outer circumferential portion to be clamped between the frame and the outer peripheral surface of the base, and the inner circumferential portion to extend inward from the frame, the inner circumferential portion comprising an opening to be spaced a distance from the inner support surface of the base.

2. The carrier apparatus of claim 1, comprising a cavity comprising a peripheral portion to be defined between the inner circumferential portion of the circumferential flange and the inner support surface of the base, the peripheral portion of the cavity to circumscribe the opening of the circumferential flange.

3. The carrier apparatus of claim 1, the distance ranges from about 0.05 mm to about 3 mm.

4. The carrier apparatus of claim 1, the outer peripheral surface of the base circumscribing the inner support surface of the base.

5. The carrier apparatus of claim 1, at least a portion of the inner support surface of the base is recessed relative to the outer peripheral surface of the base.

6. The carrier apparatus of claim 5, the base comprising a lip circumscribing the recessed portion of the inner support surface of the base and extending between the recessed portion of the inner support surface of the base and the outer peripheral surface of the base.

7. The carrier apparatus of claim 1, the inner circumferential portion of the circumferential flange comprising a bend.

8. The carrier apparatus of claim 1, the inner support surface of the base comprising a planar portion.

9. The carrier apparatus of claim 1, the inner support surface of the base comprising a non-planar portion.

10. The carrier apparatus of claim 9, at least a portion of the non-planar portion of the inner support surface of the base is raised relative to the outer peripheral surface of the base.

11. The carrier apparatus of claim 9, the base comprising a protrusion between the non-planar portion of the inner support surface of the base and the outer peripheral surface of the base.

12. A carrier apparatus comprising:
an article comprising a first major surface, a second major surface, a thickness between the first major surface and the second major surface, and an edge extending across the thickness between the first major surface and the second major surface;
a base comprising an outer peripheral surface and an inner support surface, the inner support surface supports the first major surface of the article;
a frame connected to the outer peripheral surface of the base; and
a circumferential flange comprising an outer circumferential portion and an inner circumferential portion, the outer circumferential portion is clamped between the frame and the outer peripheral surface of the base, the inner circumferential portion extends inward from the frame and contacts the article, thereby securing the article to the inner support surface of the base, the inner circumferential portion of the circumferential flange defines an opening that exposes an exposed area of the second major surface of the article, and the circumferential flange isolates at least a portion of the edge of the article from the exposed area of the second major surface of the article.

13. The carrier apparatus of claim 12, the thickness of the articles ranges from about 0.1 mm to about 3 mm.

14. The carrier apparatus of claim 12, the circumferential flange defines a sealed cavity that isolates the portion of the edge of the article from the exposed area of the second major surface of the article.

15. The carrier apparatus of claim 12, at least a portion of the inner support surface of the base is recessed relative to the outer peripheral surface of the base.

16. The carrier apparatus of claim 15, the base comprising a lip circumscribing the article and extending between the recessed portion of the inner support surface of the base and the outer peripheral surface of the base.

17. The carrier apparatus of claim 15, a distance perpendicular to the recessed portion of the inner support surface of the base between the recessed portion of the inner support surface of the base and the second major surface of the article is greater than a parallel distance between the recessed portion of the inner support surface of the base and the outer peripheral surface of the base.

18. The carrier apparatus of claim 12, the inner circumferential portion of the circumferential flange comprising a bend that applies a force to the article thereby securing the article to the inner support surface of the base.

19. The carrier apparatus of claim 18, the bend comprises at least one of an elastically deformed portion and a plastically deformed portion of the circumferential flange.

20. The carrier apparatus of claim 18, the bend comprises a preformed portion of the circumferential flange.

21. The carrier apparatus of claim 12, the inner support surface of the base comprises a planar portion, the first major surface of the article comprises a planar portion, and the second major surface of the article comprises a planar portion, and the planar portion of the inner support surface of the base engages the planar portion of the first major surface of the article.

22. The carrier apparatus of claim 12, the inner support surface of the base comprises a non-planar portion, the first major surface of the article comprises a non-planar portion, and the second major surface of the article comprises a non-planar portion, and the non-planar portion of the inner support surface of the base engages the non-planar portion of the first major surface of the article.

23. The carrier apparatus of claim 22, at least a portion of the non-planar portion of the inner support surface of the base is raised relative to the outer peripheral surface of the base.

24. The carrier apparatus of claim 22, the base comprising a protrusion between the non-planar portion of the inner support surface of the base and the outer peripheral surface of the base, the protrusion contacting at least a portion of the edge of the article.

25. The carrier apparatus of claim 12, the article comprising a sheet comprising glass, glass-ceramic, ceramic, or combinations thereof.

26. A method of processing the carrier apparatus of claim 12, comprising:
coating the exposed area of the second major surface of the article with a coating material.

27. The method of claim 26, comprising fixing the carrier apparatus to a rotatable drum, and then rotating the rotatable drum while coating the exposed area of the second major surface of the article with the coating material.

28. The method of claim 26, comprising placing the carrier apparatus in a vacuum enclosure and drawing a vacuum on the carrier apparatus within the vacuum enclosure prior to coating the exposed area of the second major surface of the article with the coating material.

29. A method of assembling a carrier apparatus comprising:
placing an article on a base, the article comprising a first major surface, a second major surface, a thickness between the first major surface and the second major surface, and an edge extending across the thickness between the first major surface and the second major surface, the base comprising an outer peripheral surface and an inner support surface, the inner support surface supports the first major surface of the article;
placing a circumferential flange relative to the base, the circumferential flange comprising an outer circumferential portion and an inner circumferential portion; and
clamping the outer circumferential portion of the circumferential flange to the outer peripheral surface of the base, the inner circumferential portion of the circumferential flange contacts the article and defines an opening that exposes an exposed area of the second major surface of the article while isolating at least a portion of the edge of the article from the exposed area.

30. The method of claim 29, comprising applying a bending moment to the circumferential flange by clamping the outer circumferential portion of the circumferential flange to the outer peripheral surface of the base, the bending moment resulting in a force being applied to the article by the inner circumferential portion of the circumferential flange, thereby securing the article to the inner support surface of the base.

31. The method of claim 29, comprising forming a sealed cavity by clamping the outer circumferential portion of the circumferential flange to the outer peripheral surface of the base, the portion of the edge of the article being disposed in the sealed cavity, thereby isolating the portion of the edge of the article from the exposed area of the second major surface of the article.

32. The method of claim 29, the article comprising a sheet comprising glass, glass-ceramic, ceramic, or combinations thereof.
